(19) United States
(12) Patent Application Publication
(10) Pub. No.: US 2015/0289442 A1
(43) Pub. Date: Oct. 15, 2015

(54) FLEXIBLE SEED METERING DISK

(71) Applicant: Appareo Systems, LLC, Fargo, ND (US)

(72) Inventors: Joseph A. Heilman, Fargo, ND (US); Barry D. Batcheller, West Fargo, ND (US); Robert V. Weinmann, Wahpeton, ND (US); Jeffrey L. Johnson, West Fargo, ND (US)

(21) Appl. No.: 14/683,039

(22) Filed: Apr. 9, 2015

Related U.S. Application Data
(60) Provisional application No. 61/977,556, filed on Apr. 9, 2014.

(51) Int. Cl. A01C 7/12

(52) U.S. Cl. CPC A01C 7/128

(57) ABSTRACT

A flexible seed metering disk, comprising a first disk layer, and a second disk layer, wherein the first disk layer has a first pattern of holes which pass completely through the first disk layer, wherein the second disk layer has a second pattern of holes which pass completely through the second disk layer, and wherein the first disk layer is placed in contact with the second disk layer such that at least a subset of holes from the first pattern of holes lines up with at least a subset of holes from the second pattern of holes, creating openings in the flexible seed metering disk which pass through both the first disk layer and the second disk layer, whereby various configurations of the flexible seed metering disk can be created by rotating the first disk layer in relation to the second disk layer to create alternative alignments.

### CROSS-REFERENCE TO RELATED APPLICATION

This application claims priority in U.S. Provisional Patent Application No. 61/977,556, filed Apr. 9, 2014, which is incorporated herein by reference.

### BACKGROUND OF THE INVENTION

1. Field of the Invention

The present invention relates generally to the field of agricultural practices of seeding and tillage, and in particular to a flexible seed metering disk.

2. Description of the Related Art

The practice of agriculture has been largely the same for many years. Advances in electronic vehicle control and sensors have allowed machines to become more efficient and for the production rate of agricultural crops to be increased dramatically. However, true advances in agriculture are not possible without veering away from these common practices and thinking in a dramatically different way.

What is needed in the art is a system for performing planting and harvesting functions which is not limited by past equipment limitations.

### SUMMARY OF THE INVENTION

This invention describes a flexible seed metering disk that allows the user of a seeding machine to change the rate and/or spacing at which seeds are dropped into a furrow by allowing the seed metering disk to be modified easily to control the number and spacing of the seeds placed.

One aspect of the present invention is a flexible seed metering disk, comprising a first disk layer, and a second disk layer, wherein the first disk layer has a first pattern of holes which pass completely through the first disk layer, wherein the second disk layer has a second pattern of holes which pass completely through the second disk layer, and wherein the first disk layer is placed in contact with the second disk layer such that at least a subset of holes from the first pattern of holes lines up with at least a subset of holes from the second pattern of holes, creating openings in the flexible seed metering disk which pass through both the first disk layer and the second disk layer, whereby various embodiments of the flexible seed metering disk can be created by rotating the first disk layer in relation to the second disk layer to create alternate alignments of the first pattern of holes with the second pattern of holes.

This aspect and others are achieved by the present invention, which is described in detail in the following specification and accompanying drawings which form a part hereof.

### BRIEF DESCRIPTION OF DRAWINGS

The accompanying drawings illustrate the principles of the present invention and an exemplary embodiment thereof.

FIG. 1A is an illustration of a seeding/planting row unit of the prior art.

FIG. 1B is an illustration of an implement with multiple row units from the prior art.

FIG. 2A is a simplified illustration of a seeding disk of the prior art.

FIG. 2B is an illustration of a seed meter from the prior art, cutaway to show the internal workings of seed delivery into the furrow.

FIG. 3 is an exploded view of the flexible seeding disk of the present invention.

FIG. 4 is an alternate exploded view of the flexible seeding disk of the present invention showing how the front and back sides of the disk are placed in regard to each other.

FIG. 5 is an illustration of how an example flexible seeding disk can be arranged such that only a subset of the seed holes is open.

FIG. 6 is an illustration of an alternate configuration of the example flexible seeding disk of FIG. 5 showing that a larger set of holes is open in this configuration.

### DETAILED DESCRIPTION OF THE PREFERRED EMBODIMENT

### I. Introduction, Environment, and Preferred Embodiment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning

### II. Preferred Embodiment Flexible Seed Metering Disk

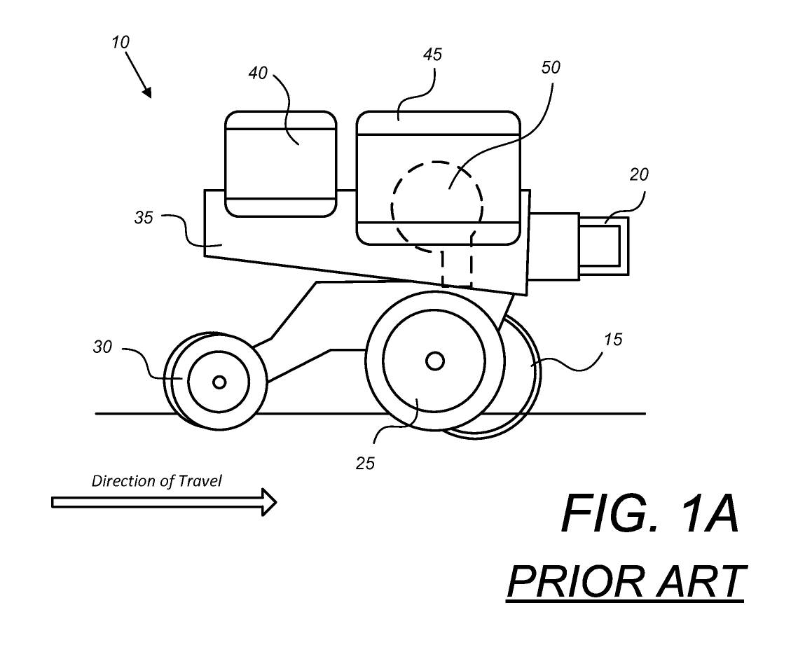

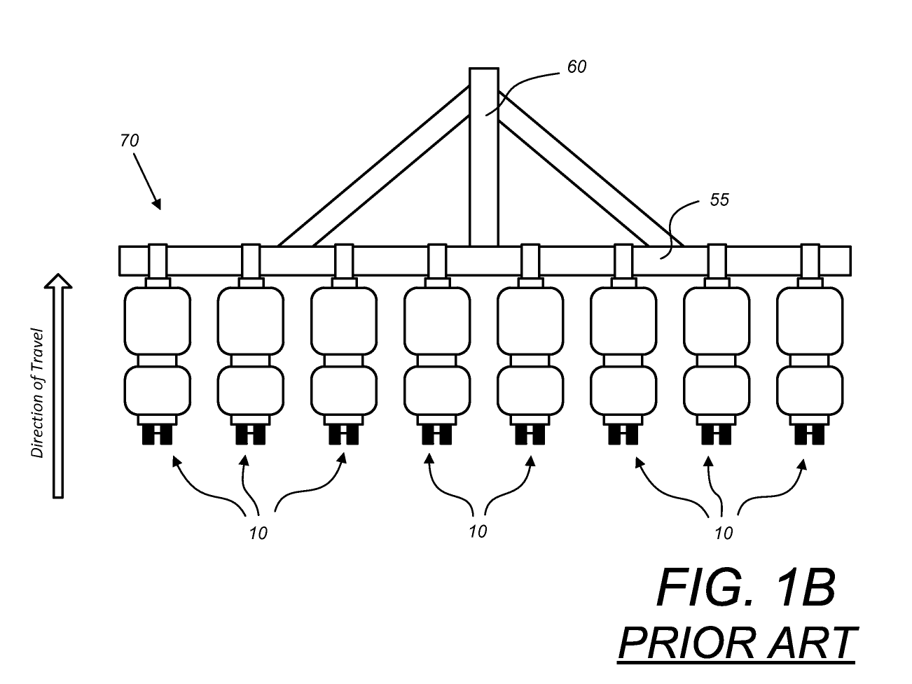

With reference now to the drawings, and in particular to FIGS. 1A through 6 thereof, a new flexible metering system will be discussed.

The planting and seeding systems that exist in the prior art today suffer several limitations that prevent dramatic increases in crop production rates and efficiency. The main limitations of the implements (planters) used for planting crops today is that they are inflexible and unaware of the best planting conditions. Seeds are dropped into the ground by fixed-space row units pulled behind a tractor which plant seeds in a set grid pattern.

One approach to addressing some of these limitations is to design more flexible seeding and planting equipment to decrease the amount of labor needed and to increase the efficiency of operations. One such design would be the flexible seed metering system described below.

FIG. 1A is an illustration of a typical seeding/planting row unit of the prior art. The device shown here is called a “row unit” as it is designed to drop a single line of seeds into a furrow that is opened as the front of the row unit is pulled through the soil. Several row units are attached to a draw bar and pulled behind a tractor in order to sow several rows of seeds at once.

Turning to FIG. 1A, the prior art row unit 10 has an opener 15 near the front that consists of a disk or similar device for cutting a furrow into the soil. There is a gauge wheel 25 used to help determine the proper depth for which the opener 15 should extend into the ground. The row unit 10 is connected by means of a towing frame 20 to the draw bar of a planting implement so that the row unit 10 can be pulled through the field. Each row unit 10 has a seed bin 45 containing the seeds that are to be planted. These seeds are fed into a seed meter 50 which is built into seed bin 45, and the seed meter 50 is responsible for dropping the seeds down into the furrow created by the opener 15 at a controlled rate.

Optionally, the row unit 10 of the prior art has one or more chemical tanks 40 that are used to hold chemicals, such as fertilizer, pesticide, etc., that may be sprayed into the furrow as the seed is dropped. The seed bin 45 and the chemical tank 40 are supported by a row unit frame 35 that provides the structural support required to hold the components of the row unit 10. In the back of the row unit 10, there are typically closing wheels 30 which pass over the furrow, pushing the displaced dirt from the furrow back into the furrow and packing it to close the furrow over the planted seed.

FIG. 1B is an illustration of an implement 70 with multiple row units 10 from the prior art. FIG. 1B shows several row units 10 attached to a single draw bar 55 to form a tow-behind agricultural implement 70, such as a planter. The draw bar 55 is itself attached to a tractor hitch 60 so that it can be pulled behind a tractor and moved through a field.

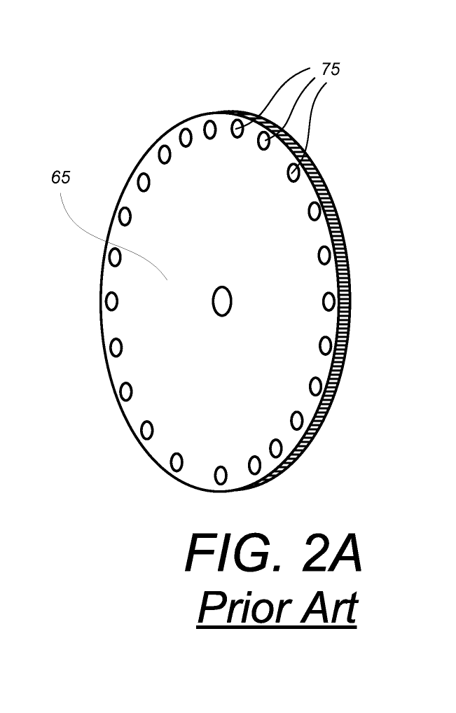

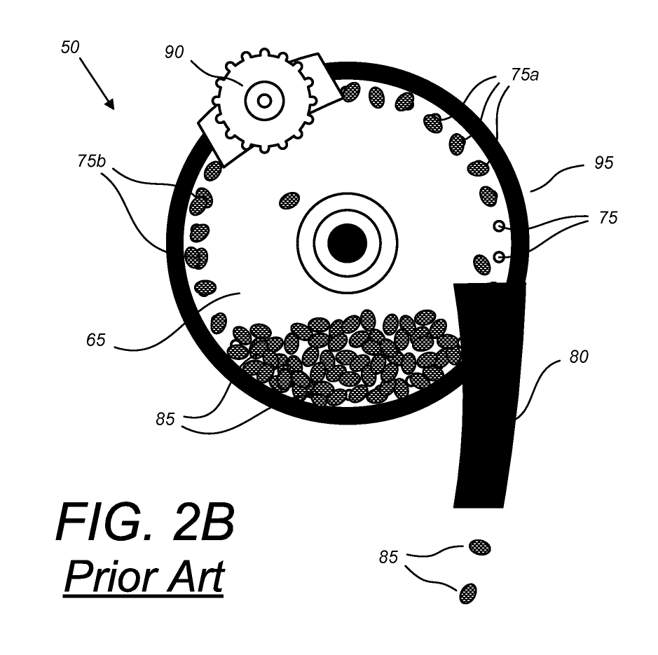

FIG. 2A is a simplified illustration of a seeding disk of the prior art. FIG. 2B is an illustration of a seed meter from the prior art, cutaway to show the internal workings of seed delivery into the furrow. For the following description, it is best to look at both drawings, FIG. 2A and FIG. 2B, at the same time. To best understand the seed meter 50 of FIG. 2B, it is helpful to understand the prior art seed disk 65 of FIG. 2A, and vice versa.

A seed meter 50 is a device built into a seed bin 45 such as the seed bin 45 in FIG. 1A. A typical seed meter 50 in the prior art comprises a seed disk 65, which is essentially a large flat circular disk with a number of holes 75 spaced around the outer edge of the disk 65. These holes 75 are typically centered in small divots in which a seed can be held, and they are extended all the way through the seed disk 65. In a typical seed meter 50, the disk 65 is mounted vertically so that its axis or rotation is substantially parallel to the ground, and the disk 65 is rotated so that the holes 75 on the edge of the disk pass through a pile of seeds 85. Suction is applied on one side of the disk 65 such that, as the holes 75 in the disk 65 pass down through the seeds 85, the suction from the opposite side of the disk 65 pulls individual seeds 85 up into each hole 75 and holds it there until each seed can be dropped into a seed tube 80 for planting.

In FIG. 2B, holes that are completely open (hold no seed) are labeled with the reference designator 75, holes that are currently holding a single seed are labeled as 75a, and holes that are holding two or more seeds are labeled as 75b. The suction that is applied to the back side of the seed disk 65 is designed to allow each hold 75 to pick up a single seed 85 as it passes through the pile of seeds 85 at the bottom of the seed meter, but sometimes more than one seed 85 is picked up. Since the goal is “singulation,” that is the handling and placement of single seeds 85 only in each hole 75, the disk 65 spins through a device known as a singulator 90, which will pick off any extra seeds 85 that are on a hole 75 (such as those shown as 75b in FIG. 2B). The singulator is well known in the prior art and will not be explained further in this specification.

After the holes 75 have passed through the singulator 90 and are now containing a single seed 85 for planting (as shown by 75a), the seed disk 65 spins the seed holes 75a to a point in travel where the suction is removed (point 95 in the embodiment shown in FIG. 2A). Once suction is removed at point 95, the seeds 85 drop straight down into the open top end of a seed tube 80, which guides them down into the furrow for planting (the furrow in the field having been opened by the opener 15 of the row unit 10 of FIG. 1A.

For a crop such as corn, you may typically use a seed disk 65 with 30 holes in it. However, for something like sunflowers, where you can plant the seeds 85 much closer, you may want to replace the seed disk 65 with another disk that has 60 holes 75 (twice as many) so that the sunflower seeds are pulled off and dropped in the furrow faster. Changing the seed disk 65 from one crop to another can be time-consuming.

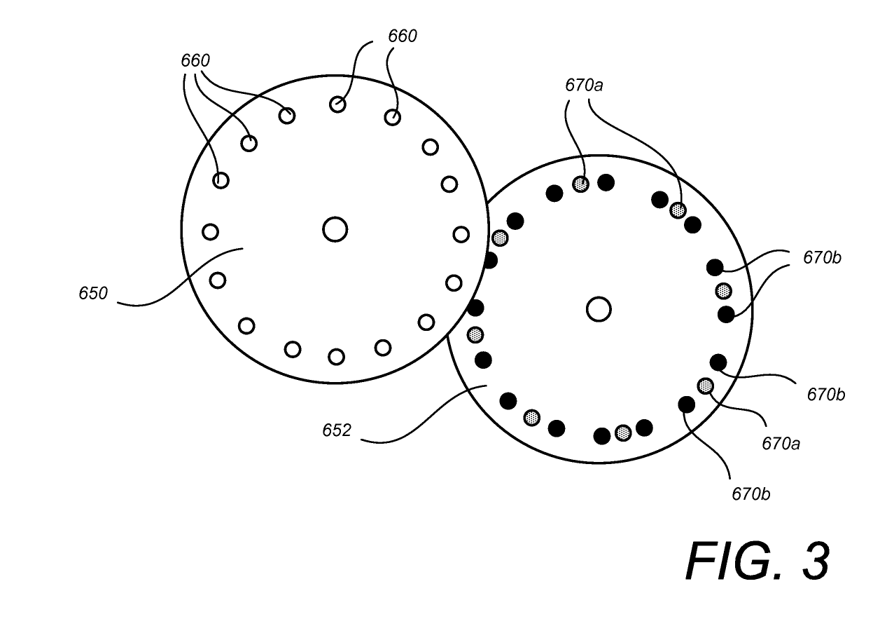

The present invention is a new type of seed disk and is illustrated in FIGS. 3 through 6.

FIG. 3 is an exploded view of the flexible seeding disk of the present invention. In FIG. 3, we see that the present invention comprises two (or more) disks placed back to back. The disks in the exploded view of FIG. 3 are shown held apart so that they both can be seen, but they would normally be pressed together to form a single disk.

The two disks used in the present invention each have a different pattern and number of holes. The “top” disk 650 will typically be thin and is essentially used to act as a cover for a select subset of holes in the “bottom” disk 652. The terms “top” and “bottom” are somewhat arbitrary and used here as a way of distinguishing the two disks from each other. In one embodiment, the top disk 650 is the side of the assembled invention that will be exposed to seeds, and the bottom disk 652 will be on the side to which suction is applied. However, this orientation is someone arbitrary, and rotating the disk of the present invention 180 degrees (so that disk 650 is on the suction side and disk 652 is on the seed side) would also work.

Having established the convention of calling disk 650 the top disk and disk 652 the bottom disk, we can discuss the difference between disk 650 and disk 652. Top disk 650 contains a single set of holes 660. Bottom disk 652 contains two separate sets of holes, 670a and 670b. All of the holes shown in these FIGS. 660, 670a, and 670b), are holes that extend all the way through the disk with which they are associated. The holes 660 in the top disk 650 may be placed in shallow divots designed to hold seeds, but air would pass through holes 660 in the same manner that it can pass through hole sets 670a and 670b. Shading has been used to distinguish holes 670a from holes 670b, but this shading is not meant to imply a functional difference between the hole sets.

Returning our attention to FIG. 3, we will think of bottom disk 652 as having two separate sets of holes, a set of 8 holes (shown with a dotted texture) and a set of 16 holes (shown as black), for a total 24 holes. The top disk 650 has 16 holes 660. When you sandwich the two disks together, the number of total holes exposed from bottom disk 652 differs depending on how top disk 650 is rotated in relation to bottom disk 652.

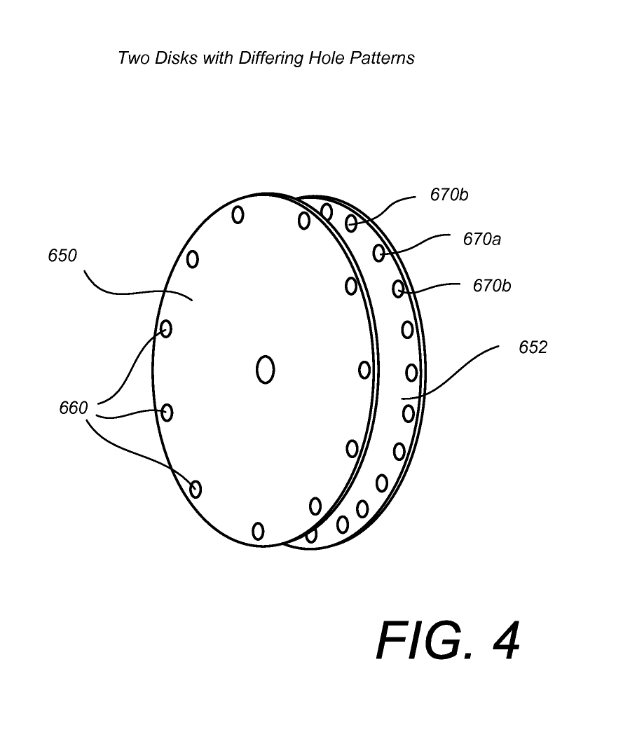

In FIG. 4, disks 650 and 652 are shown in a perspective view as they would be brought together to make the completed disk of the present invention. FIG. 4 is presented for clarity, showing the still unattached disks closer together in order to illustrate how the amount of spin of the top disk 650 against the bottom disk 652 will expose a different number or set of holes on the bottom disk 652.

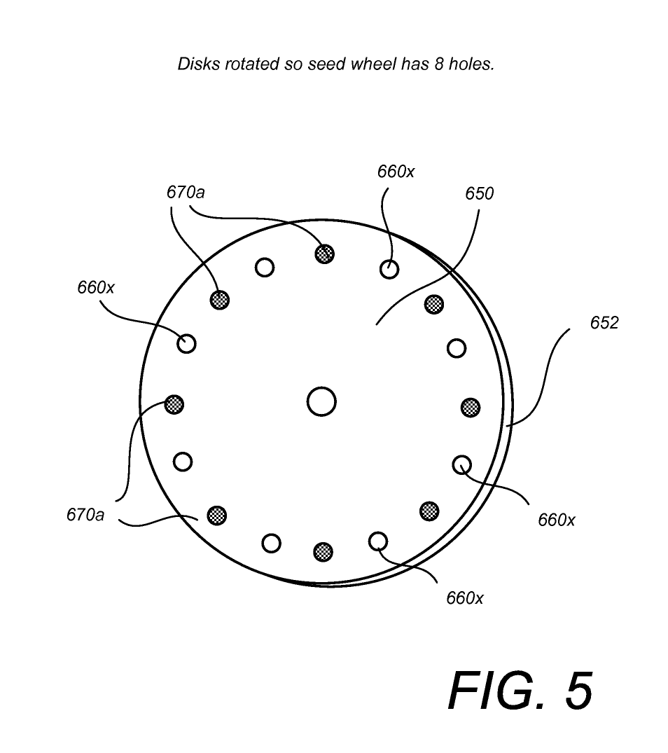

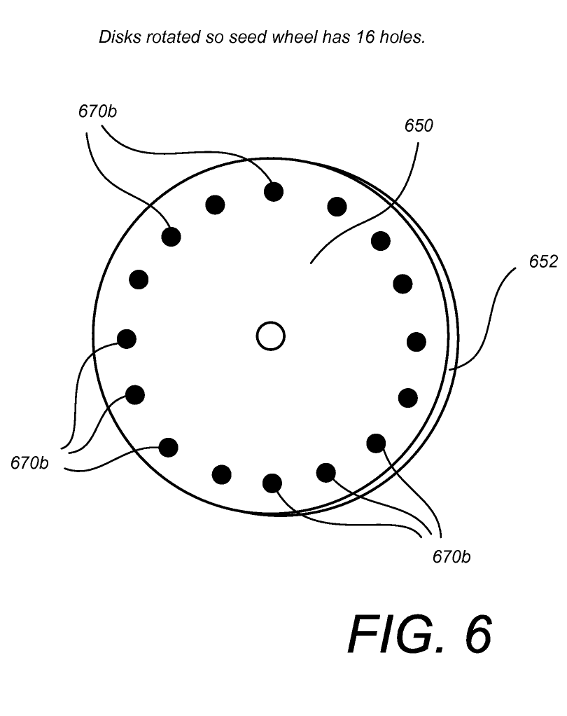

FIGS. 5 and 6 show how disks 650 and 652 can be rotated in relation to each other to expose different sets of holes that pass all the way through both disks. In FIG. 5, disks 650 and 652 are rotated such that holes 670a from disk 652 are lined up with some of the holes 660 from disk 650. The holes in FIG. 5 shown as 670a will pass all the way through both disks, allowing air to pass through those eight locations so that suction can be applied to those holes 670a. Holes 660x are where holes 660 on disk 650 line up with a solid portion of disk 652, so that no air will pass through the seed disk in those locations 660x. In the configuration of FIG. 5, the assembled seed disk has 8 open holes.

Turning now to FIG. 6, disks 650 and 652 are rotated such that holes 670b from disk 652 are lined up with all of the holes 660 from disk 650. The holes in FIG. 6 shown as 670b (all holes shown as completely black in FIG. 6) will pass all the way through both disks, allowing air to pass through those 16 locations so that suction can be applied to those holes 670b. In the configuration of FIG. 6, the assembled seed disk has 16 open holes, or twice the number of holes as shown in FIG. 5.

In this way, by rotating the two disks in relation to each other, two different versions of the seed disk can be made: one with 8 holes and one with 16 holes, creating a flexible seed disk which can be easily changed without removing the entire disk and replacing it with an entirely different disk.

Having described the preferred embodiments, it will become apparent that various modifications can be made without departing from the scope of the invention as defined in the accompanying claims.

For example, it may be possible to create other hole patterns in the two disks to allow more than two sets of holes. It may also be possible to place more than two disks together, each with a different pattern, to allow the creation of increasingly varied hole patterns from a single seed disk formed in this manner.

It may also be possible to create multiple concentric circles of holes in the two disks, so that only one of the circular patterns of holes is visible at a time, each circle of holes having a different number of holes. Other patterns of holes and disk layer combinations could be made to create variations and alternate embodiments of the invention that do not vary from the inventive concepts thus presented.

It is to be understood that while certain aspects of the disclosed subject matter have been shown and described, the disclosed subject matter is not limited thereto and may include various other embodiments and aspects.

Having thus described the invention, what is claimed as new and desired to be secured by Letters Patent is:

1. A flexible seed metering disk, comprising:
a first disk layer;
a second disk layer;
wherein the first disk layer has a first pattern of holes which pass completely through the first disk layer, wherein the second disk layer has a second pattern of holes which pass completely through the second disk layer, and wherein the first disk layer is placed in contact with the second disk layer such that at least a subset of holes from the first pattern of holes lines up with at least a subset of holes from the second pattern of holes, creating openings in the flexible seed metering disk which pass through both the first disk layer and the second disk layer; and
whereby various configurations of the flexible seed metering disk can be created by rotating the first disk layer in relation to the second disk layer to create alternate alignments of the first pattern of holes with the second pattern of holes.
